(19) United States
(12) Patent Application Publication
(10) Pub. No.: US 2010/0101150 A1
(43) Pub. Date: Apr. 29, 2010

(54) SUSPENSION WHEEL APPARATUS FOR GLASS DOORS

(76) Inventor: Shih-Chang HUANG, Kaohsiung County (TW)

Correspondence Address: Muncy, Geissler, Olds & Lowe, PLLC, P.O. BOX 1364, FAIRFAX, VA, 22038-1364, US

(21) Appl. No.: 12/259,667

(22) Filed: Oct. 28, 2008

(51) Int. Cl. E05D 15/06

(52) U.S. Cl. 49/409

(57) ABSTRACT

A suspension wheel apparatus for glass doors includes a suspension wheel set, a wheel seat and a bridging element. The bridging element is screwed on a clamping fixture to hold a glass door and has an arched round head held by the wheel seat to form an arched surface contact. Thus the bridging element can be directed to an upright position without skewing forwards, rearwards, leftwards or rightwards. The wheel seat has a conical orifice to increase the swinging room of the bridging element. Therefore, the glass door can be moved smoothly and steadily for opening or closing in close contact with a track, and adjustment can be made accurately and securely.

### FIELD OF THE INVENTION

The present invention relates to a suspension wheel apparatus for glass doors that can be assembled and installed quickly and firmly and in close contact with a track during moving to facilitate smooth opening and closing of a suspension glass door and is simpler to make adjustment and can provide secured suspension.

### BACKGROUND OF THE INVENTION

A conventional suspension wheel apparatus 10 used on glass doors (referring to FIG. 1) generally has a suspension wheel set 11, a wheel seat 12 and a bridging element 13. The bridging element 13 is fastened to a clamping fixture 20 by screwing to hold a glass door 21 and engaged with the suspension wheel set 11. The bridging element 13 also is screwed and runs through the wheel seat 12. The wheel seat 12 has a bottom 121 in flat contact with a flat surface formed on an inner rim 111 of the suspension wheel set 11. Such a structure still has drawbacks in practice, notably:

Referring to FIG. 2, as the bottom 121 of the wheel seat 12 is in flat contact with the inner rim 111 of the suspension wheel set 11, when a suspension glass door 21 is moved for opening or closing, it is prone to sway forwards, rearwards, leftwards or rightwards. And the suspension wheel apparatus 10 hanging the suspension glass door 21 is not directed and positioned accurately in an upright manner. This could affect secured suspension of the glass door 21.

### SUMMARY OF THE INVENTION

The primary object of the present invention is to provide a suspension wheel apparatus for glass doors to overcome the aforesaid problem occurred to the conventional technique that can be assembled and installed quickly and firmly on the top of a glass door and in close contact with a track during moving to facilitate smooth opening and closing of the suspension glass door and is simpler to make adjustment and provides secured suspension.

To achieve the foregoing object, the suspension wheel apparatus of the invention mainly includes a suspension wheel set, a wheel seat and a bridging element.

The suspension wheel set has a first hole and a second hole formed respectively on the top and bottom thereof, a housing chamber in the middle communicating with the first and second holes, and apertures formed at two sides thereof to be hinged by a first wheel set and a second wheel set.

The wheel seat is held in the housing chamber of the suspension wheel set and formed with a hexagonal shape and has an opening in the center. The opening has an upper half section formed an upper concave curve with an inner side widened gradually upwards, and a lower half section adjacent to the bottom of the upper concave curve and expanded gradually downwards to become a conical orifice.

The bridging element has an arched round head at one end in contact with the upper concave curve of the wheel seat and a screw bar extended downwards from the arched round head to run through the wheel seat.

By means of the structure set forth above, when the suspension glass door is moved for opening or closing, the arched round head at the upper side of the bridging element can sway in the upper concave curve to direct swinging amplitude in an upright position without skewing forwards, rearwards, leftwards or rightwards. The conical orifice of the wheel seat further provides more swinging room for the screw bar of the bridging element. Therefore, the suspension glass door can be moved smoothly on a track in a close contact manner, and the glass door also can be hung steadier to enhance safety.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic front view of a conventional suspension wheel apparatus and a clamping fixture in a coupling condition.

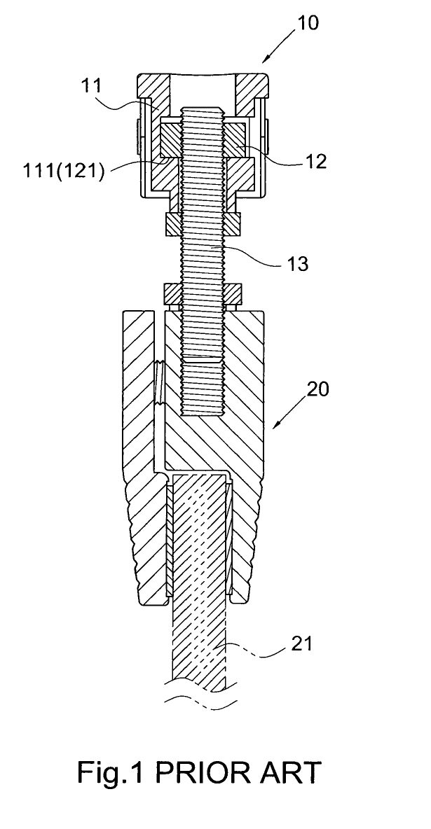

FIG. 2 is a schematic view of the conventional suspension wheel apparatus according to FIG. 1 being not able to adjust the glass door accurately.

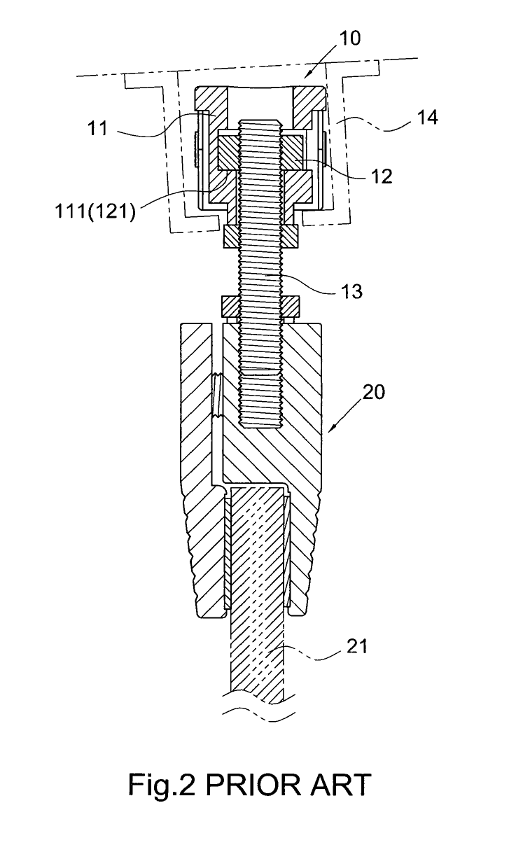

FIG. 3 is an exploded view of the invention.

FIG. 4A is a perspective view of the invention.

FIG. 4B is a cross section taken on line 4B-4B in FIG. 4A.

FIG. 5 is an exploded view of the bridging element and the wheel seat of the invention.

FIG. 6 is a schematic view of the arched round head of the bridging element in the wheel seat to adjust the swinging amplitude.

FIG. 7 is a schematic view of the suspension wheel apparatus of the invention in a condition of adjusting a glass door in an upright position.

FIG. 8 is a front view of the suspension wheel apparatus of the invention coupling with a clamping fixture to hold a glass door.

### DETAILED DESCRIPTION OF THE PREFERRED EMBODIMENT

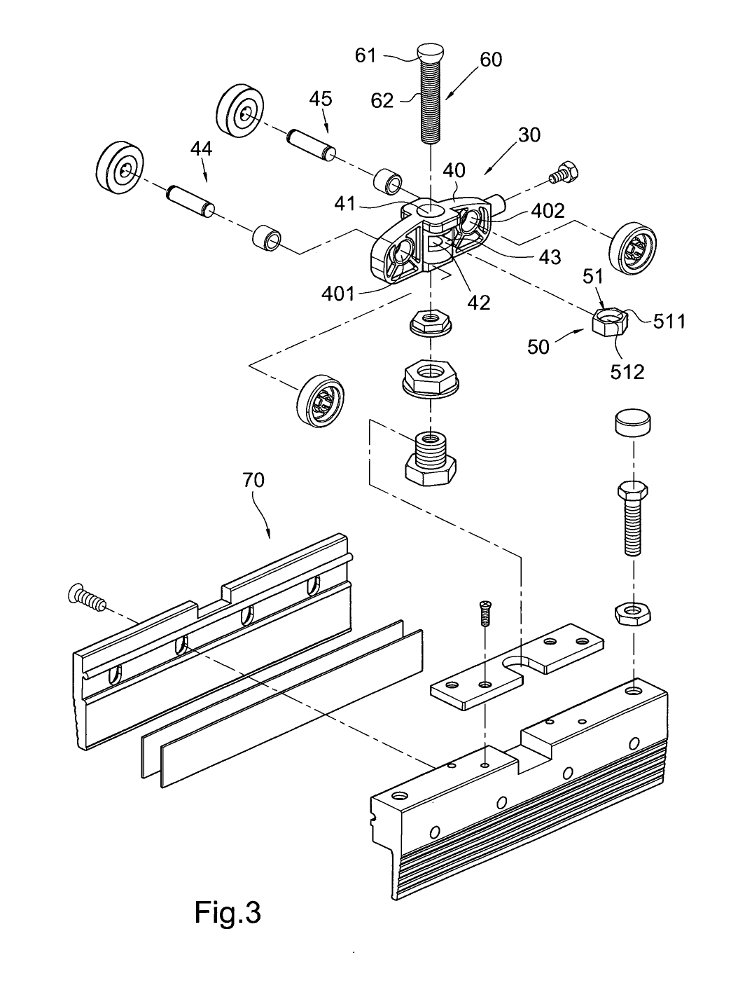

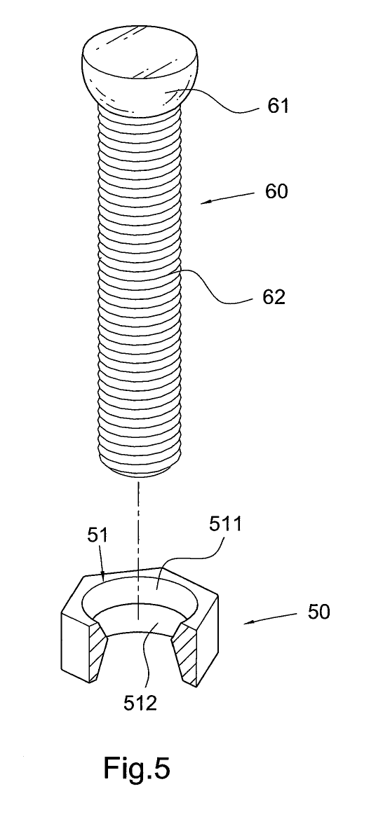

Refer to FIGS. 3, 4A, 4B, and 5 for an embodiment of the invention. The suspension wheel apparatus 30 according to the invention mainly includes a suspension wheel set 40, a wheel seat 50 and a bridging element 60.

The suspension wheel set 40 has a first hole 41 and a second hole 42 formed respectively on the top and bottom thereof, a housing chamber 43 in the middle communicating with the first and second holes 41 and 42, and apertures 401 and 402 formed at two sides thereof to be hinged by a first wheel set 44 and a second wheel set 45.

The wheel seat 50 is held in the housing chamber 43 of the suspension wheel set 40 and formed with a hexagonal shape in this embodiment, and has an opening 51 in the center. The opening 51 has an upper half section formed an upper concave curve 511 with an inner side widened gradually upwards, and a lower half section adjacent to the bottom of the upper concave curve 511 and expanded gradually downwards to become a conical orifice 512. The conical orifice 512 can increase the swinging space of a screw bar 62 of the bridging element 60.

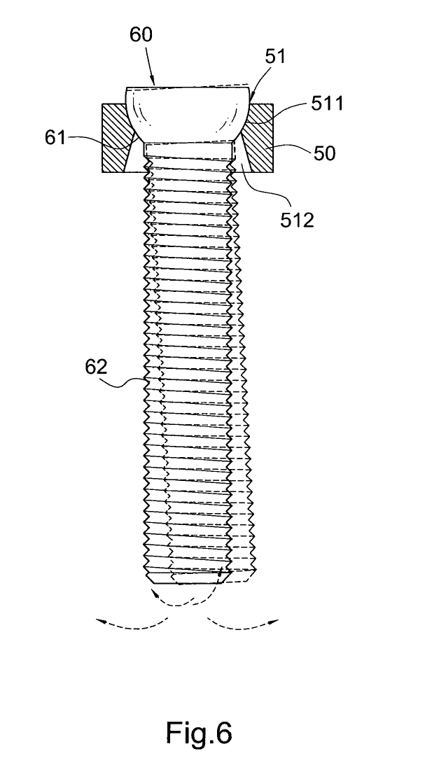

The bridging element 60 has an arched round head 61 at one end in contact with the upper concave curve 511 of the wheel seat 50. The arched round head 61 and the upper concave curve 511 have a curved surface structure to direct swinging amplitude to an upright condition so that a suspension glass door 71 can be moved for opening or closing without skewing forwards, rearwards, leftwards or rightwards (referring to FIG. 6). The screw bar 62 is extended downwards from the arched round head 61 to run through the wheel seat 50 held in the housing chamber 43 of the suspension wheel set 40 and fastened by screwing a clamping fixture 70 to clamp the glass door 71.

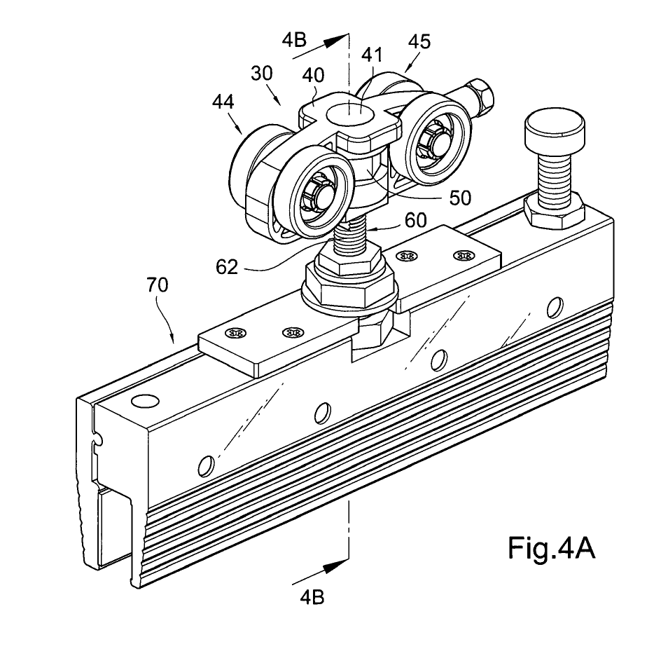

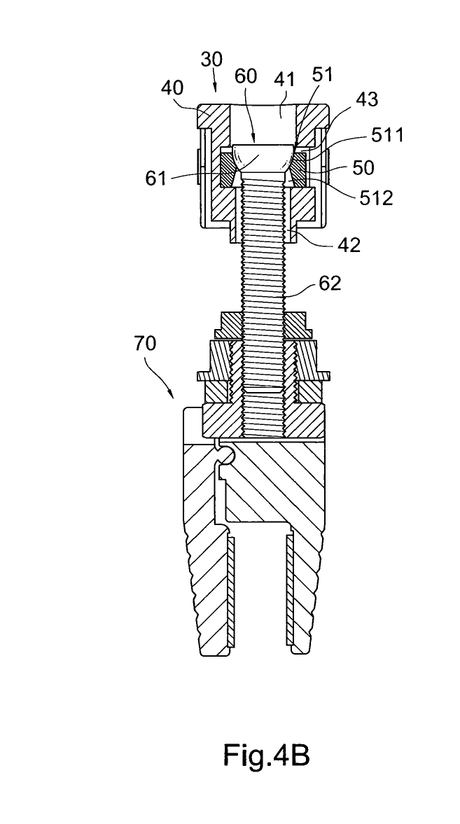

By means of the construction set forth above, for assembly and installation, also referring to FIGS. 4A and 4B, install the suspension wheel apparatus 30 on a track 80 with the wheel seat 50 held in the housing chamber 43 of the suspension wheel set 40; have the screw bar 62 of the bridging element 60 run through the opening 51 of the wheel seat 50 and fastened to the clamping fixture 70 by screwing to clamp the glass door 71; dispose the arched round head 61 at one end of the bridging element 60 on the upper concave curve 511 of the wheel seat 50 so that they are in contact with each other and a swinging adjustment can be made as desired. Therefore, the suspended glass door 71 can be moved for opening or closing without skewing forwards, rearwards, leftwards or rightwards (referring to FIG. 6). The screw bar 62 has more swinging amplitude due to the conical orifice 512 of the wheel seat 50.

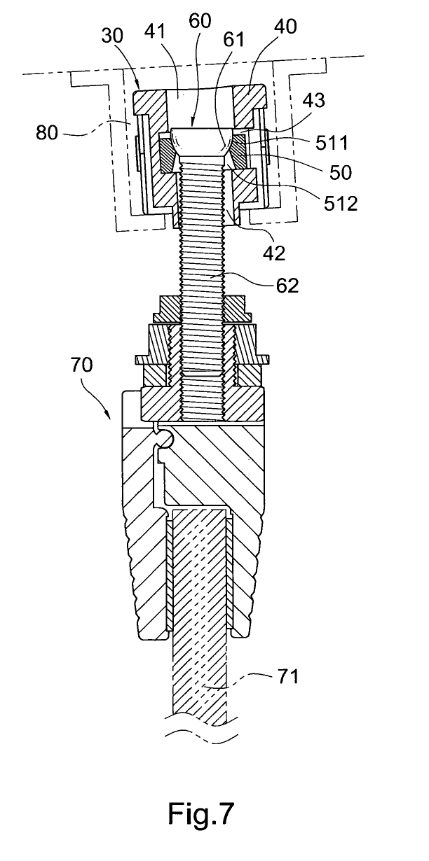

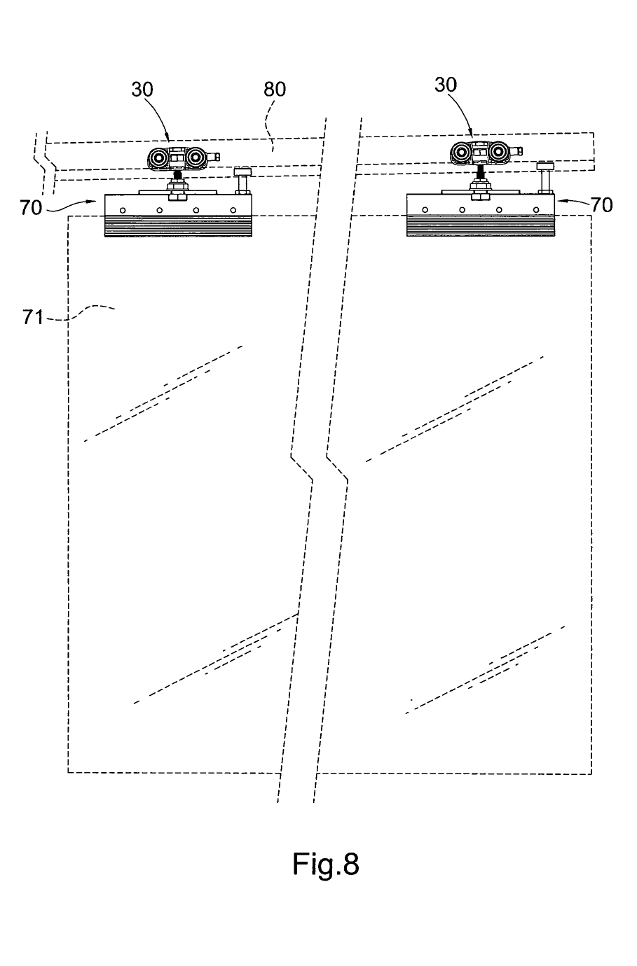

Referring to FIGS. 7 and 8, when the suspension wheel apparatus 30 is positioned on an uneven track 80 and the suspension glass door 71 is moved for opening or closing, in the event that the glass door 71 is skewed or not fully aligned with a door frame in a closed condition, through the curved surface structure of the arched round head 61 and upper concave curve 511 of the invention, a contact swinging (referring to FIG. 6) can be formed, and the screw bar 62 of the bridging element 60 held in the conical orifice 512 of the wheel seat 50 can be directed to swing to the upright position in the increased swinging space (referring to FIG. 7). Thus skewing of the glass door 71 forwards, rearwards, leftwards or rightwards can be prevented. The glass door 71 can be moved smoothly and steadily on the track 80 in a close contact manner, and safety is enhanced.

As a conclusion, the suspension wheel apparatus 30 of the invention can adjust the suspension glass door 71 as desired. The arched round head 61 and upper concave curve 511 provide a curved surface contact to direct the swinging amplitude to the upright position so that the suspension glass door 71 can be moved during opening and closing without skewing forwards, rearwards, leftwards or rightwards. The conical orifice 512 of the wheel seat 50 provides more swinging space for the screw bar 62 of the bridging element 60. The suspension wheel apparatus 30 can be installed quickly and firmly at the top portion of the glass door 71. Suspension of the glass door 71 can be adjusted easier. It provides a significant improvement over the conventional technique.

What is claimed is:

1. A suspension wheel apparatus for glass doors, comprising:
a suspension wheel set which has a first hole on the top, a second hole at the bottom, a housing chamber in the middle communicating with the first hole and the second hole, and apertures formed at two sides to be hinged respectively by a first wheel set and a second wheel set;
a wheel seat which is held in the housing chamber of the suspension wheel set and has an opening in the center, the opening having an upper half section formed an upper concave curve and a lower half section formed a conical orifice; and
a bridging element which has an arched round head at one end in contact with the upper concave curve and a screw bar extended downwards from the arched round head to run through the wheel seat held in the housing chamber of the suspension wheel set.

2. The suspension wheel apparatus of claim 1, wherein the wheel seat is formed in an angular shape.

3. The suspension wheel apparatus of claim 1, wherein the upper concave curve of the opening in the wheel seat is widened gradually upwards.

4. The suspension wheel apparatus of claim 1, wherein the conical orifice of the opening in the wheel seat is widened gradually downwards from the bottom of the upper concave curve.
